(19) United States
(12) Patent Application Publication
(10) Pub. No.: US 2007/0205917 A1
(43) Pub. Date: Sep. 6, 2007

(54) Saf-T-Light

(76) Inventors: Lonnie Nickson, Montgomery, AL (US); Deborah Nickson, Montgomery, AL (US)

Correspondence Address: Raymond M. Galasso;Galasso & Associates LP, P.O. Box 26503, Austin, TX, 78755-0503, US

(21) Appl. No.: 11/704,596

(22) Filed: Feb. 9, 2007

Related U.S. Application Data
(60) Provisional application No. 60/772,207, filed on Feb. 10, 2006.

(51) Int. Cl. G09F 21/02; G08G 1/095

(52) U.S. Cl. 340/907; 340/908; 40/586

(57) ABSTRACT

Saf-T-Light is a battery-operated hand held sign that provides backlighting to a warning or instruction message. The preferred embodiment of the invention utilizes eight fluorescent light bulbs powered by a battery and attached to an octagonal frame having a handle and translucent panels with stop and go messaging for attachment to the frame. To use Saf-T-Light, an individual installs the batteries into the handle of the device and the appropriate translucent panels into the frame of the device. The user can then turn on the power switch on the handle and show whichever side of the frame is necessary. For example, the Stop panel will be shown when traffic or crowd flow should cease and the Go panel will be rotated to be shown when traffic or crowd flow should proceed.

### CROSS REFERENCE TO RELATED APPLICATIONS

This United States Non-Provisional patent application claims priority to U.S. Provisional Patent Application No. 60/772,207 entitled “Saf-T-Light” filed Feb. 10, 2006.

### FIELD OF THE DISCLOSURE

The disclosures made herein relate generally to the safety accessories industry. The invention discussed herein is in the general classification of signs to be used for crowd and traffic control.

### BACKGROUND

Crowd control is a primary concern at many sporting events, concerts, construction sites or other high traffic areas. Traffic controllers at road construction sites, police officers at sporting events and concerts and school-crossing guards at public and private institutions are often tasked with moving a large group of people in a short time frame. Traditionally, a traffic controller uses a plain octagonal, metal stop sign without any lighting or utilizes his or her hands to waive people forward or make people stop. These techniques are inadequate because the traffic controller must often operate at night or in weather conditions where visibility of these traditional signals can be affected.

Hence, there is a need in the art for a convenient to use, inexpensive, durable, safe and effective device for controlling traffic and crowd flow.

### SUMMARY OF THE DISCLOSURE

Saf-T-Light is a battery-operated hand held sign that provides backlighting to a warning or instruction message.

The preferred embodiment of the invention utilizes eight fluorescent light bulbs powered by a battery and attached to an octagonal frame having a handle and translucent panels with stop and go messaging for attachment to the frame.

Other embodiments of the invention may incorporate a different number or style of lighting and messaging.

The principal object of this invention is to provide a device to alert crowds when to proceed or stop.

Another object of this invention is to provide a device to alert drivers in traffic when to move or stop their vehicles.

Another object of this invention is to provide an affordable device for alerting individuals when to proceed or stop.

Another object of this invention is to provide a safe device for alerting individuals when to proceed or stop.

Yet another object of this invention is to provide a durable device for alerting individuals when to proceed or stop.

### BRIEF DESCRIPTION OF THE DRAWINGS

FIG. 1 depicts a perspective view of the preferred embodiment of the invention with the translucent panels and batteries removed.

FIG. 2 depicts a frontal view of the preferred embodiment of the invention.

### DETAILED DESCRIPTION OF THE DRAWINGS

The preferred embodiment of Saf-T-Light is comprised of at least some of the following: eight fluorescent light bulbs powered by a battery and attached to an octagonal frame having a handle with a power switch and translucent panels with stop and go messaging for attachment to the frame.

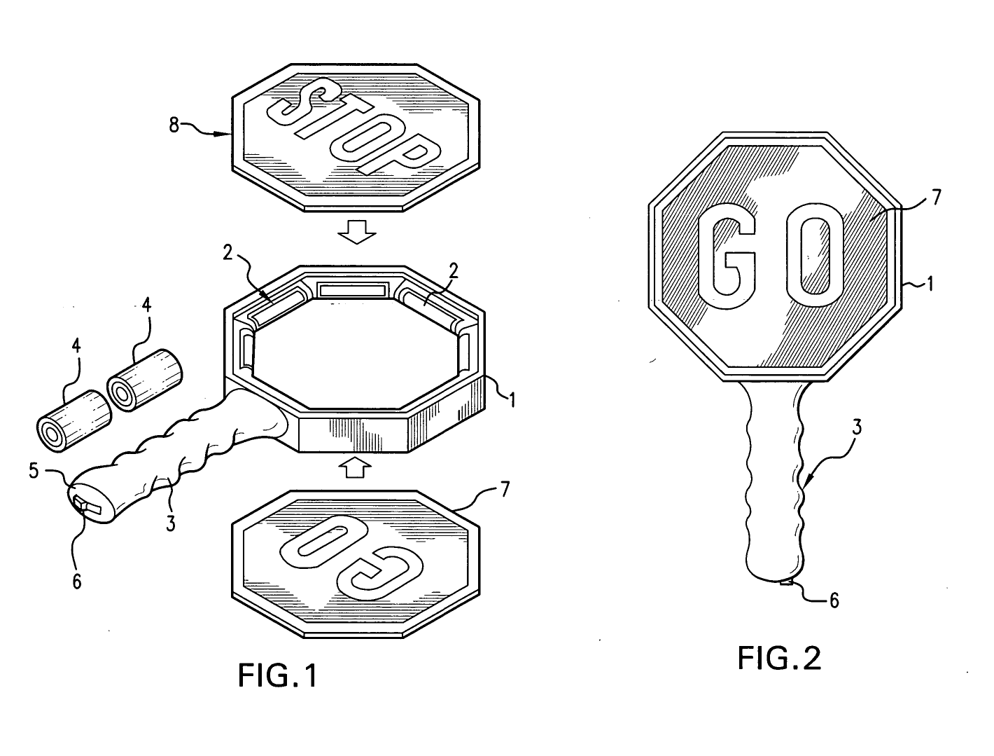

FIG. 1 depicts a perspective view of the preferred embodiment of the invention with the translucent panels and batteries removed. An octagonal frame 1 has eight equal length sides. The octagonal frame 1 is made of plastic and is fourteen inches in width, fourteen inches in length and one and a half inches in depth in this preferred embodiment. Fluorescent lights 2 are attached to each of the sides of the octagonal frame 1. The fluorescent lights 2 are made from elongated light bulbs that extend almost the length of each side of the frame 1. Although other types of light bulbs could also be utilized and could be attached to a variety of spots on the frame 1, the fluorescent lights 2 around the perimeter are preferred to maximize visibility by evenly distributing the lighting. For example, simple backlighting could be accomplished with a single plain white light bulb attached to the frame.

A handle 3 is attached to one of the sides of the frame 1 in this preferred embodiment. The handle 3 is approximately cylindrical with a length of six inches and a diameter of two inches. The handle 3 is made of foam or rubber in the preferred embodiment for operator comfort. A grooved pattern is present on the handle 3 to provide for better gripping. The handle 3 is screwed into the bottom of the frame 1 in this preferred embodiment though it could also be permanently attached or attached via a variety of other well known removable methods. Batteries 4 are also inserted into the bottom of the handle 3 after the cap 5 is removed. A power switch 6 is also located on the bottom of the handle 3 to allow the fluorescent lights 2 to be controlled.

A translucent panel 7 that is octagonal in shape and dimensioned to fit inside the frame 1 displays a “Go” message. The translucent panel 7 could display a variety of messages in a variety of colors. In this particular embodiment, the translucent panel 7 is green and has white lettering.

Another translucent panel 8 that is octagonal in shape and dimensioned to fit inside the frame 1 displays a “Stop” message. This translucent panel 8 could also display a variety of messages in a variety of colors. In this particular embodiment, the translucent panel 8 is red and has white lettering.

The frame 1 and handle 3 are also waterproof in this preferred embodiment to permit use in all types of weather conditions.

FIG. 2 depicts a frontal view of the preferred embodiment of the invention. The frame 1, handle 3, power switch 6 and translucent panel 7 are visible from this view.

To use Saf-T-Light, an individual installs the batteries into the handle of the device and the appropriate translucent panels into the frame of the device. The user can then turn on the power switch on the handle and show whichever side of the frame is necessary. For example, the Stop panel will be shown when traffic or crowd flow should cease and the Go panel will be rotated to be shown when traffic or crowd flow should proceed.

The materials utilized for Saf-T-Light may vary widely but will likely include metals, plastic and electronic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Saf-T-Light can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of metals, plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A warning and instruction device comprising:
(a) a handle attached to a frame;
(b) a light bulb attached to the frame; and
(c) a panel that can be inserted into the frame;

2. The device of claim 1 wherein the handle is cylindrical with a grooved pattern.

3. The device of claim 1 wherein the handle is made of foam.

4. The device of claim 1 wherein the handle is made of rubber.

5. The device of claim 1 wherein the handle is six inches in length and two inches in width.

6. The device of claim 1 wherein the frame is octagonal.

7. The device of claim 1 wherein the frame is made of plastic and has a width of fourteen inches, a length of fourteen inches and a thickness of one and a half inches.

8. The device of claim 1 wherein the handle and the frame are waterproof.

9. The device of claim 1 wherein the light bulb is fluorescent.

10. The device of claim 1 wherein the light bulb is attached to the perimeter of the frame.

11. The device of claim 1 wherein the handle screws into the bottom of the frame.

12. The device of claim 1 further comprising
a power source operatively attached to the light bulb.

13. The device of claim 12 wherein the power source is a battery located in the bottom of the handle.

14. The device of claim 1 further comprising
a cap located on the bottom of the handle.

15. The device of claim 1 further comprising
a power switch located on the handle

16. The device of claim 1 wherein the panel is translucent and has lettering.

17. A warning and instruction device comprising:
(a) an octagonal frame having a first side, a second side, a third side, a fourth side, a fifth side, a sixth side, a seventh side, and an eighth side of equal length;
(b) a handle attached to the first side of the octagonal frame.
(c) a first fluorescent light bulb attached to and extending approximately the length of the first side, a second fluorescent light bulb attached to and extending approximately the length of the second side; a third fluorescent light bulb attached to and extending approximately the length of the third side, a fourth fluorescent light bulb attached to and extending approximately the length of the fourth side, a fifth fluorescent light bulb attached to and extending approximately the length of the fifth side, a sixth fluorescent light bulb attached to and extending approximately the length of the sixth fluorescent light bulb, a seventh fluorescent light bulb attached to and extending approximately the length of the seventh side and an eighth fluorescent light bulb attached to and extending approximately the length of the eighth side;
(d) a first translucent panel dimensioned to be inserted into the front of the octagonal frame and a second translucent panel dimensioned to be inserted into the rear of the octagonal frame opposite the first translucent panel;
(e) a battery located in the handle operatively attached to the first fluorescent light bulb, the second fluorescent light bulb, the third fluorescent light bulb, the fourth fluorescent light bulb, the fifth fluorescent light bulb, the sixth fluorescent light bulb, the seventh fluorescent light bulb and the eighth fluorescent light bulb; and
(f) a power switch and a cap located on the handle.

18. The device of claim 17 wherein the handle is approximately cylindrical and has a grooved pattern.

19. The device of claim 17 wherein the handle is made of foam.

20. The device of claim 17 wherein the handle is screwed into the first side of the octagonal frame.
